(19) United States
(12) Patent Application Publication
(10) Pub. No.: US 2026/0064833 A1
(43) Pub. Date: Mar. 5, 2026

(54) SYSTEMS AND METHODS FOR RECORDING SUSPICIOUS ACTIVITY

(71) Applicant: Derrick Vernon,, JR., Foster City, CA (US)

(72) Inventor: Derrick Vernon,, JR., Foster City, CA (US)

(21) Appl. No.: 19/274,028

(22) Filed: Jul. 18, 2025

Related U.S. Application Data
(60) Provisional application No. 63/689,951, filed on Sep. 3, 2024.
(60) Provisional application No. 63/818,119, filed on Jun. 5, 2025.

(51) Int. Cl. G06F 21/55; G06F 21/60

(52) U.S. Cl. CPC G06F 21/552; G06F 21/604; G06F 2221/034

(57) ABSTRACT

A computer-implemented method for recording suspicious activity may include (i) detecting, by a computing device, an attempt by a person to access a protected object, (ii) in response to detecting the attempt, activating, by the computing device, at least one hidden camera that is configured to capture video of the person accessing the protected object, and (iii) storing, by the computing device, in a secure data storage location, the video of the person accessing the protected object. Various other methods, systems, and computer-readable media are also disclosed.

### CROSS-REFERENCE TO RELATED APPLICATIONS

This application claims the benefit of priority under 35 U.S.C. § 119 (e) of U.S. Provisional Application No. 63/689,951, filed 3 Sep. 2024, and U.S. Provisional Application No. 63/818,119, filed 5 Jun. 2025, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for recording suspicious activity.

FIG. 2 is a flow diagram of an exemplary method for recording suspicious activity.

FIG. 3 is an illustration of an exemplary system for recording suspicious activity.

FIG. 4 is a block diagram of an exemplary system for recording suspicious activity.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Traditional security systems often rely on hardware components and manual monitoring to secure properties and/or data. While effective in some scenarios, these systems have limitations in dealing with insider threats who may be aware of and capable of disabling or ignoring existing security systems. The present disclosure is generally directed to systems and methods for recording suspicious activity with a hidden camera triggered by attempts to access protected objects and/or tamper with more obvious security systems.

In some embodiments, the systems described herein may improve the functioning of a computing device by securing the computing device against malicious activity. Additionally, the systems described herein may improve the fields of physical and/or digital security and/or insider threat detection by recording suspicious activity performed by insiders that would not be captured by security systems known to the insiders.

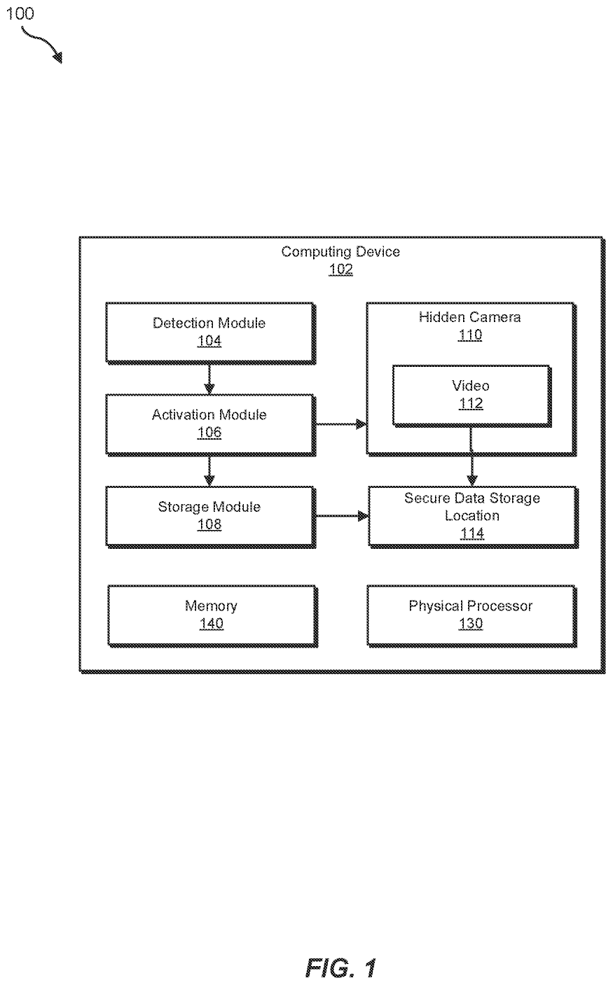

In some embodiments, the systems described herein may be installed on a computing device. FIG. 1 is a block diagram of an exemplary system 100 for recording suspicious activity. In one embodiment, and as will be described in greater detail below, a computing device 102 may be configured with a detection module 104 that may detect an attempt by a person to access a protected object. In response to detecting the attempt, an activation module 106 may activate at least one hidden camera 110 that is configured to capture video 112 of the person accessing the protected object. Next, a storage module 108 may store, in a secure data storage location 114, video 112.

Computing device 102 generally represents any type or form of computing device capable of reading computer-executable instructions. For example, computing device 102 may represent a personal computing device. Alternatively, computing device 102 may represent a camera and/or external storage and/or processing attached to a camera. In some embodiments, computing device 102 may be and/or include a sensor such as a motion detector, etc. Additional examples of computing device 102 may include, without limitation, a laptop, a desktop, a wearable device, a smart device, an artificial reality device, a personal digital assistant (PDA), a security system, an alarm system, one or more networked cameras, etc.

Hidden camera 110 may represent any type or form of device that is capable of capturing and/or recording video data and that is installed, mounted, and/or otherwise configured to be difficult to detect by an observer. For example, hidden camera 110 may be a closed-circuit television (CCTV) camera installed such that only the lens is visible or such that no part of hidden camera 110 is visible. In some embodiments, hidden camera 110 may be concealed within furniture, architecture, and/or other features of a building and/or vehicle. For example, hidden camera 110 may be installed behind a one-way mirror, within a computing device that does not typically include a camera such as a printer, or in a piece of furniture such as a picture frame. In some examples, hidden camera 110 may be installed such that only an administrator and/or owner of the facility is aware of the presence of hidden camera 110 and standard users of the facility (e.g., employees, customers, guests, etc.) are not.

Video 112 generally represents any type or form of video data. In some examples, video 112 may include audio data. Video 112 may be recorded and/or stored in any suitable aspect ratio, quality, and/or format. In some embodiments, video 112 may be captured by multiple hidden cameras.

Secure data storage location 114 generally represents any type or form of data storage location including local storage on a computing device and/or external storage device (e.g., hard drive, etc.), remote storage in a data center (e.g., cloud storage, etc.), etc. In some embodiments, secure data storage location 114 may require authorization to access. Additionally, secure data storage location 114 may be configured to be hidden from most users and may require authorization to view. For example, secure data storage location 114 may be configured to be hidden from typical users and most device administrators but may be visible to a user authenticated as the organization's owner.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation,

Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

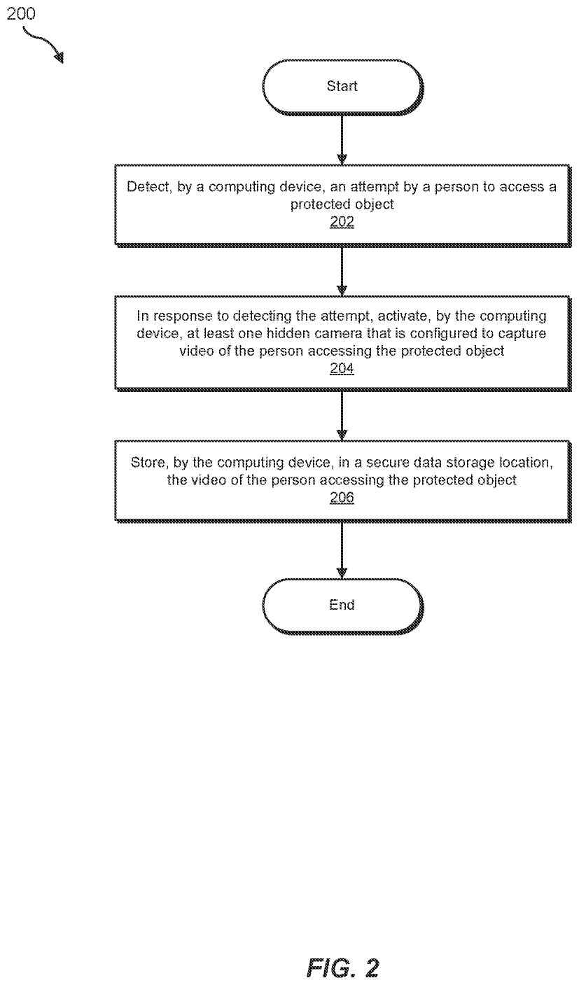

FIG. 2 is a flow diagram of an exemplary method 200 for recording suspicious activity. In some examples, at step 202, the systems described herein may detect an attempt by a person to access a protected object.

The term “protected object,” as used herein, may generally refer to any type of physical or virtual object. For example, a protected object may be a physical object such as currency, medication, sensitive physical documents, weapons, valuable devices, and so forth. In other examples, a protected object may be data such as financial data, personally identifying information, confidential information, and so forth. The protected object may be protected in a variety of ways. For example, the protected object may be in a designated area, such as currency stored in a till, medication stored in a restricted area of a pharmacy, items stored in a safe, and so on. In some examples, the protected object may be tagged with a physical tag or otherwise marked as protected. Protected data may be protected by requiring authorization and/or authentication to access, being tagged as protected or sensitive data, being protected by digital security systems, and so forth.

The systems may detect a variety of types of attempts to access protected objects. For example, the systems described herein may detect an attempt to physically access a protected area and/or object, such as opening a safe or till, entering a restricted area, etc. In other examples, the systems described herein may detect an attempt to access protected data, such as by opening and/or modifying one or more files, authenticating to a system that includes protected data, initiating a transaction that includes and/or modifies protected data (e.g., a file transfer, a financial transfer, etc.), and so forth.

In some examples, the systems described herein may detect an attempt to access a protect object by detecting tampering with a system that protects the protected object. For example, the systems described herein may detect an attempt to disable and/or otherwise circumvent a security system. In one example, the systems described herein may detect an attempt to turn off an alarm system. In another example, the systems described herein may detect an attempt to turn off one or more security cameras. In some examples, the systems described herein may detect attempts to turn off and/or circumvent digital security systems such as authentication systems, firewalls, anti-malware systems, activity recording systems, and so forth.

In some examples, the systems described herein may detect an attempt to access a protected object by a person who is authorized to interact with the object but capable of performing unauthorized actions with the object. For example, a bank teller may be authorized to move currency between multiple storage locations if this activity is properly recorded but may not be authorized to move currency into a safe without creating a record and may not be authorized to move currency into their personal belongings at all. Similarly, a pharmacist may be authorized to take medication that has been prescribed out of a secure storage area but may not be authorized to remove additional medication from that area. In one example, an administrator may be authorized to view and modify sensitive digital files but not transmit those digital files to other devices. In some embodiments, the systems described herein may detect attempts to access protected objects that are ultimately benign but may monitor these attempts in case the attempt becomes malicious.

The systems described herein may detect the attempt in a variety of ways. For example, the systems described herein may detect the attempt via one or more motion detectors that detect motion near the protected object. In another example, the systems described herein may detect the attempt via a proximity detector, camera, and/or any other suitable type of sensor. In some embodiments, the systems described herein may detect an attempt to access a protected digital object via monitoring software.

In some embodiments, the systems described herein may detect every attempt to access a protected object. In some embodiments, the systems described herein may only activate a hidden camera if the attempt has suspicious characteristics. For example, if the attempt occurs outside normal hours for that type of activity (e.g., a bank teller accesses the vault after hours), involves an usual quantity or size of transactions (e.g., of digital financial transactions), doesn't match up with expected procedure (e.g., a pharmacist accessing controlled medication without a corresponding prescription), involves turning off a security system, involves an unexpected person (e.g., an employee identified by facial recognition or other systems who should not be in a restricted area), involves one or more failed authentication attempts, and/or has any other unusual or suspicious characteristics. In one embodiment, the systems described herein may use an artificial intelligence (AI) algorithm to determine if an attempt to access a protected object is suspicious.

At step 204, in response to detecting the attempt, the systems described herein may activate at least one hidden camera that is configured to capture video of the person accessing the protected object.

The systems described herein may capture the video in a variety of ways and/or contexts. In some embodiments, one or more hidden cameras may be positioned to capture the person accessing a physical location where the object is stored, such as a safe, a till, etc. Additionally, or alternatively, one or more cameras may be positioned to capture a screen of a device on which a person is interacting with a protected digital object. In some embodiments, the systems described herein may include additional digital components that perform auditing functions, such as screen-recording software, a keylogger, and/or other such software. In some embodiments, one or more hidden cameras may be installed inside a building. Additionally, or alternatively, one or more hidden cameras may be installed inside a vehicle, such as an armored truck for safely transporting currency and/or documents, a military vehicle, etc.

At step 206, the systems described herein may store, in a secure data storage location, the video of the person accessing the protected object.

The systems described herein may store the video in a variety of ways and/or contexts. In some embodiments, the systems described herein may store the video locally (e.g., on the computing device). Additionally, or alternatively, the systems described herein may store the video remotely. In some embodiments, the systems described herein may store the video such that the subject of the video is unaware of the recording. For example, the systems described herein may store the video in a hidden location that is not visible to most users of the system. In some embodiments, a specific type of authorization (e.g., that of the head of security, the head of the organization, etc.) may be required in order for the systems described herein to make the video available to a user.

In some embodiments, the systems described herein may send an alert to a pre-designated user, such as an owner or an administrator, when a video recording is initiated and/or completed. The alert may include various information, such as the time of the incident, location of the incident, the video recording, a link and/or instructions to view the video recording, and so forth.

In some embodiments, the systems described herein may perform analysis of the video. For example, the systems described herein may use facial recognition to identify one or more people in the video. In one embodiment, the systems described herein may collect data from other systems, such as security systems, biometric authentication systems, login systems, and so forth, in order to identify people and/or objects in the video.

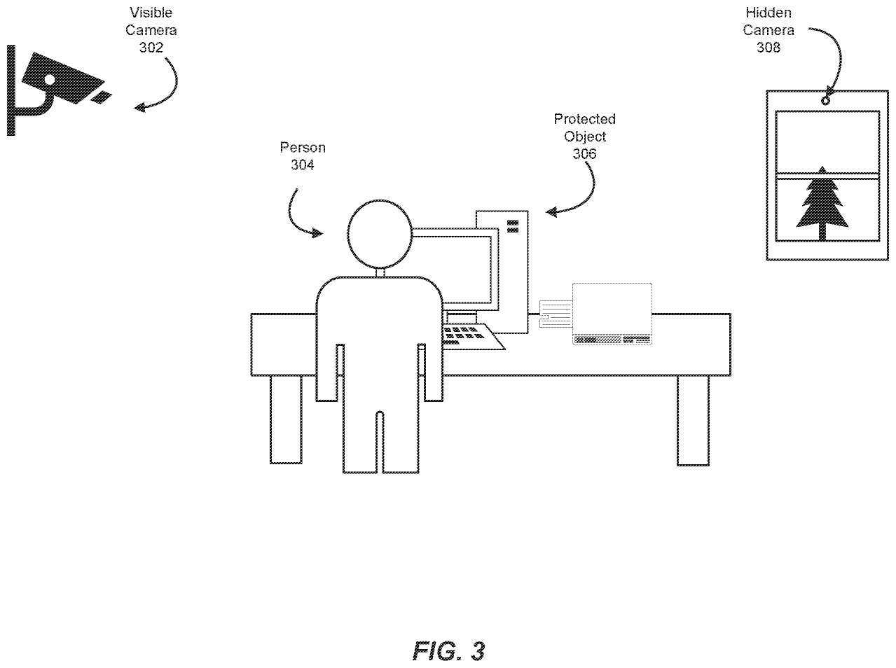

In one example, the systems described herein may activate when a person turns off a security system such as a visible camera. For example, as illustrated in FIG. 3, a person 304 may deactivate a visible camera 302 in preparation to perform a malicious activity involving access to a protected object 306, such as making an unauthorized financial transaction on a computing device. In this example, a hidden camera 308 may be positioned to capture interactions between person 304 and protected object 306 and may capture video of person 304 making the unauthorized financial transaction. In one example, the systems described herein may then alert an administrator about the transaction.

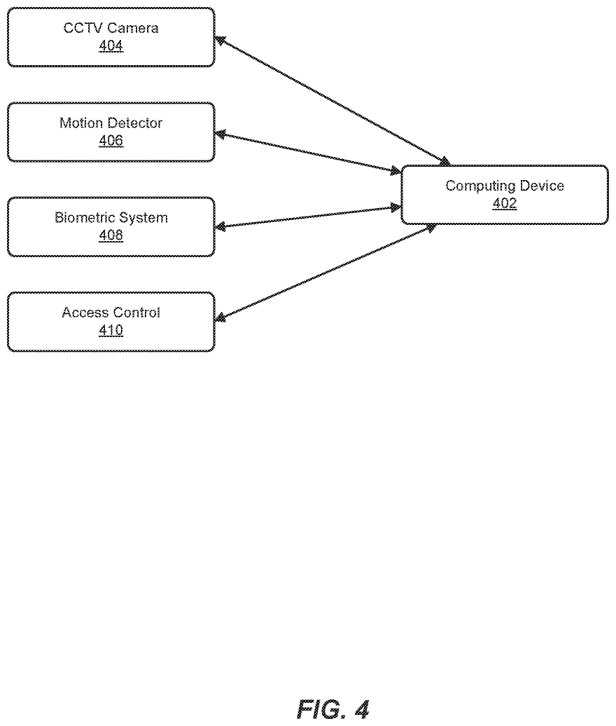

In some embodiments, the systems described herein may use multiple physical and/or digital systems to detect, identify, and record insider threats. For example, as illustrated in FIG. 4, a computing device 402 configured with the systems described herein may communicate with a CCTV camera 404 that captures video of an insider threat, a motion detector 406 that activates CCTV camera 404 when detecting motion near a protected object, a biometric system 408 that identifies a person in the footage captured by CCTV camera 404 (e.g., through facial recognition, via a fingerprint or iris scan taken by a separate device, etc.), and/or an access control 410 that identifies the insider threat (e.g., via an authorization or authentication system). In some embodiments, access control 410 may deny or grant authorization to access a protected object based at least in part on identifications provided by biometric system 408.

As described above, the systems and methods described herein may detect suspicious and/or malicious actions by insider threats by monitoring interactions with protected objects via one or more hidden cameras not known to insiders. In some examples, an insider may be largely familiar with an organization's security systems and may disable such systems, such as visible cameras, alarm systems, etc., before engaging in malicious behavior, such as theft of physical goods, unauthorized digital transactions, and so forth. The systems described herein may capture this behavior with one or more hidden cameras and store this footage to secure, hidden storage, thus significantly increasing the chances that insider threats will be successfully caught and/or prosecuted.

### EXAMPLE EMBODIMENTS

In some aspects, the techniques described herein relate to a computer-implemented method including: detecting, by a computing device, an attempt by a person to access a protected object; in response to detecting the attempt, activating, by the computing device, at least one hidden camera that is configured to capture video of the person accessing the protected object; and storing, by the computing device, in a secure data storage location, the video of the person accessing the protected object.

In some aspects, the techniques described herein relate to a computer-implemented method, wherein the attempt to access the protected object includes an attempt to access protected data.

In some aspects, the techniques described herein relate to a computer-implemented method, wherein the protected data is stored on the computing device.

In some aspects, the techniques described herein relate to a computer-implemented method, further including activating, in response to detecting the attempt to access the protected data, an auditing process on a device that stores the protected data.

In some aspects, the techniques described herein relate to a computer-implemented method, wherein detecting the attempt to access the protected data includes detecting an unusual pattern of digital transactions.

In some aspects, the techniques described herein relate to a computer-implemented method, wherein the attempt to access the protected object includes an attempt to access a physical object.

In some aspects, the techniques described herein relate to a computer-implemented method, wherein detecting the attempt by a person to access the protected object includes detecting an attempt to disable a security measure.

In some aspects, the techniques described herein relate to a computer-implemented method, wherein detecting the attempt to disable the security measure includes detecting an attempt to disable a camera.

In some aspects, the techniques described herein relate to a computer-implemented method, wherein detecting the attempt to disable the security measure includes detecting an attempt to disable an alarm system.

In some aspects, the techniques described herein relate to a computer-implemented method, wherein storing the video in the secure data storage location includes storing the video in a data storage location that requires authorization to access.

In some aspects, the techniques described herein relate to a computer-implemented method, wherein the person does not have the authorization to access the data storage location.

In some aspects, the techniques described herein relate to a computer-implemented method, wherein storing the video in the secure data storage location includes storing the video in a hidden data storage location that is not visible to the person.

In some aspects, the techniques described herein relate to a computer-implemented method, further including sending an alert to an administrator in response to detecting the attempt by the person to access the protected object.

In some aspects, the techniques described herein relate to a computer-implemented method, wherein the at least one hidden camera is installed in a building.

In some aspects, the techniques described herein relate to a computer-implemented method, wherein the at least one hidden camera is installed in a vehicle.

In some aspects, the techniques described herein relate to a computer-implemented method, wherein detecting the attempt by the person to access the protected object includes detecting motion by at least one motion detector.

In some aspects, the techniques described herein relate to a computer-implemented method, wherein detecting the attempt by the person to access the protected object includes identifying the person via facial recognition.

In some aspects, the techniques described herein relate to a computer-implemented method, wherein the computing device includes the hidden camera.

In some aspects, the techniques described herein relate to a system including: at least one physical processor; physical memory including computer-executable instructions that, when executed by the physical processor, cause the physical processor to: detect, by a computing device, an attempt by a person to access a protected object; in response to detecting the attempt, activate, by the computing device, at least one hidden camera that is configured to capture video of the person accessing the protected object; and store, by the computing device, in a secure data storage location, the video of the person accessing the protected object.

In some aspects, the techniques described herein relate to a non-transitory computer-readable medium including one or more computer-readable instructions that, when executed by at least one processor of a computing device, cause the computing device to: detect, by a computing device, an attempt by a person to access a protected object; in response to detecting the attempt, activate, by the computing device, at least one hidden camera that is configured to capture video of the person accessing the protected object; and store, by the computing device, in a secure data storage location, the video of the person accessing the protected object.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory,

Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive sensor data to be transformed, transform the sensor data to detect interactions with a protected object, output a result of the transformation to detect potentially suspicious activity, use the result of the transformation to activate one or more hidden cameras, and store the result of the transformation to a secure storage location. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
detecting, by a computing device, an attempt by a person to access a protected object;
in response to detecting the attempt, activating, by the computing device, at least one hidden camera that is configured to capture video of the person accessing the protected object; and
storing, by the computing device, in a secure data storage location, the video of the person accessing the protected object.

2. The computer-implemented method of claim 1, wherein the attempt to access the protected object comprises an attempt to access protected data.

3. The computer-implemented method of claim 2, wherein the protected data is stored on the computing device.

4. The computer-implemented method of claim 2, further comprising activating, in response to detecting the attempt to access the protected data, an auditing process on a device that stores the protected data.

5. The computer-implemented method of claim 2, wherein detecting the attempt to access the protected data comprises detecting an unusual pattern of digital transactions.

6. The computer-implemented method of claim 1, wherein the attempt to access the protected object comprises an attempt to access a physical object.

7. The computer-implemented method of claim 1, wherein detecting the attempt by a person to access the protected object comprises detecting an attempt to disable a security measure.

8. The computer-implemented method of claim 7, wherein detecting the attempt to disable the security measure comprises detecting an attempt to disable a camera.

9. The computer-implemented method of claim 7, wherein detecting the attempt to disable the security measure comprises detecting an attempt to disable an alarm system.

10. The computer-implemented method of claim 1, wherein storing the video in the secure data storage location comprises storing the video in a data storage location that requires authorization to access.

11. The computer-implemented method of claim 10, wherein the person does not have the authorization to access the data storage location.

12. The computer-implemented method of claim 1, wherein storing the video in the secure data storage location comprises storing the video in a hidden data storage location that is not visible to the person.

13. The computer-implemented method of claim 1, further comprising sending an alert to an administrator in response to detecting the attempt by the person to access the protected object.

14. The computer-implemented method of claim 1, wherein the at least one hidden camera is installed in a building.

15. The computer-implemented method of claim 1, wherein the at least one hidden camera is installed in a vehicle.

16. The computer-implemented method of claim 1, wherein detecting the attempt by the person to access the protected object comprises detecting motion by at least one motion detector.

17. The computer-implemented method of claim 1, wherein detecting the attempt by the person to access the protected object comprises identifying the person via facial recognition.

18. The computer-implemented method of claim 1, wherein the computing device comprises the hidden camera.

19. A system comprising:
at least one physical processor;
physical memory comprising computer-executable instructions that, when executed by the physical processor, cause the physical processor to:
detect, by a computing device, an attempt by a person to access a protected object;
in response to detecting the attempt, activate, by the computing device, at least one hidden camera that is configured to capture video of the person accessing the protected object; and
store, by the computing device, in a secure data storage location, the video of the person accessing the protected object.

20. A non-transitory computer-readable medium comprising one or more computer-readable instructions that, when executed by at least one processor of a computing device, cause the computing device to:
detect, by a computing device, an attempt by a person to access a protected object;
in response to detecting the attempt, activate, by the computing device, at least one hidden camera that is configured to capture video of the person accessing the protected object; and
store, by the computing device, in a secure data storage location, the video of the person accessing the protected object.
